(19) United States
(12) Patent Application Publication
(10) Pub. No.: US 2026/0086005 A1
(43) Pub. Date: Mar. 26, 2026

(54) Filtration Device and Method

(71) Applicant: Robert John Fraser Reardon, London (GB)

(72) Inventor: Robert John Fraser Reardon, London (GB)

(21) Appl. No.: 19/106,253

(22) PCT Filed: Aug. 25, 2023
(86) PCT No.: PCT/EP2023/073392

§ 371 Date: Feb. 25, 2025

(30) Foreign Application Priority Data
Aug. 26, 2022 (EP) 22192466.5

(51) Int. Cl. G01N 1/34; B01D 29/11; B01L 3/00

(52) U.S. Cl. CPC G01N 1/34; B01D 29/117; B01L 3/502753; B01D 2201/4092; B01L 2300/0681; B01L 2300/0832

(57) ABSTRACT

A method of sieving or filtering solid or semisolid biological samples e.g. stool or faecal samples is described. The method allows convenient collection of the resulting matter and/or liquid by centrifugation in a compatible laboratory tube. Accordingly, a sieving or filtering device is described having a first, open end and a second, closed end, wherein at least a portion of the walls are perforated, wherein the exterior of the device has means for mounting a first vessel in fluid connection with the first end of the device, and wherein the exterior of the device has means for mounting a second vessel in fluid connection with the second end of the device, such that when the first and second vessels are mounted on the device a sealed volume is formed wherein the interior volumes of the first and second vessels and the interior volume of the device are in fluid connection. A sample in the first vessel may be urged into the second vessel via the device under centrifugation. In addition, a system for manufacturing the filtering device comprising an injection moulding tool is also provided.

The present invention relates to apparatuses and methods for filtration or sieving of material. In particular, the invention relates to sieving or filtering devices whose walls are either perforated or comprise mesh material. In addition, such sieving or filtering devices are suitable for centrifugation and/or use in a laboratory. In particular, devices of the invention are suitable for location and/or retention in cooperating vessels (e.g., laboratory tubes) such that samples of material saved or otherwise processed by passage through the perforations or filter sections of the device are retained by the vessel. Accordingly, the invention also relates to methods for use of the product of the invention in sieving, homogenising, grading, or otherwise processing samples. These methods are particularly for use in the context of centrifugation and/or laboratory use. Thus, the cooperating vessels are suitably laboratory tubes. The invention also encompasses methods of manufacture of the products of the invention and use of the products of the invention for the adaptation of diagnostic tests and techniques. These methods and techniques are particularly suited for processing of biological samples.

The centrifuge and the disposable tubes used for centrifuges are central to biological research and analysis. The ability of a centrifuge tube to be accelerated to pellet samples such that the desired fraction of a liquid or suspended material is separated and/or rendered conveniently available is used in virtually all facets of biological research and biological testing. Thus the centrifuge and associated equipment, such as disposable laboratory tubes and spin columns are an essential part of a myriad of diagnostic techniques and tests.

Many types of solid or semisolid samples are processed for diagnostic techniques. One such example is therefore animal or human faecal or stool samples. Typically such samples are collected and put in a fixative agent (e.g. formaldehyde) for later processing and diagnostic testing.

Typically, the preferred method for processing such samples for testing is to sieve the material and then centrifuge it to produce a supernatant and with a sediment/pellet. The sediment and supernatant may then be conveniently separated.

This processing has previously been achieved by loading the sample into a first vessel and then locating a second, receiving vessel mouth-to-mouth with the sample vessel. The two vessels may then be joined in fluid connection by a linking component that further comprises a sieve or filter within the path of the fluid connection. Furthermore, such an assembly may then be subjected to centrifugation such that the sample is driven against the filter/sieve towards the receiving vessel of the assembly where the pellet and supernatant are further separated. Thus, the sieving and separation steps may be carried out simultaneously.

Such a filter or sieve assembly for use in concert with laboratory tubes is manufactured by Apacor, UK. In this case a linking component allows the sample and receiving tubes to be mounted two opposing sides of the linking component, thus sealing the assembly together and containing the sample within. The filter section of the linking component is arranged “vertically” with respect to the assembly, i.e. the filter is plainer and located axially with respect to the assembly. Furthermore, the part of the linking component containing the filter section protrudes axially from the linking section into the volume of the sample vessel. This allows greater sieving/filtering surface area to be placed in the flow path of the sample material being processed as it is driven from the sample vessel towards the receiving vessel. Thus, the filtrate moves radially through the vertically arranged filter before then moving axially again to be collected into the receiving vessel. Furthermore, this axial arrangement of the sieving/filtering element means the filter does not have to support the whole weight of the centrifuged material at any point during the centrifugation process. This is in contrast to arranging the sieve/filter element transversely so that it directly covers the mouth of the sample and/or receiving vessel.

Thus, increasing the area of filter used by allowing it to protrude within the volume of the sample tube necessarily reduces the volume of the sample that may be processed. Increasing the length of the linking component is also not conveniently achieved because of the limited space that is available within standard laboratory centrifuges.

Furthermore, all tests are only as accurate and reliable as the volumes of samples and reagents on which they depend. Erroneous results may arise from use of too little sample.

Thus, there exists a need for improved separation devices that are capable of utilising a greater proportion of the volume within sample and/or receiving vessels in order that larger samples may be processed. In addition, the assemblies comprising a sample vessel, a receiving vessel and filtering/sieving component interposed between these vessels need to be the same size, or not significantly larger, in order that the standard size vessels may fit within laboratory apparatus that are currently in widespread use, especially centrifuges.

It is therefore an object of the invention to provide an improved method of sieving or filtering solid or semisolid biological samples. Additionally, it is an object of the invention that the resulting matter and/or liquid should be conveniently collected. It is a further object of the invention that the resulting matter and/or liquid should be centrifuged in order to provide a supernatant and pellet of solid matter. It is a further object of the invention that standard size laboratory tubes should be used for the sample vessel and/or the receiving vessel and that the invention will allow the processing of larger amount of sample in such a standard size vessel than has been possible hitherto.

Accordingly, it is a further object of the invention to provide apparatus that may be used to carry out the improved methods of sieving, grading, or filtering solid or semisolid biological samples noted above. In particular, it is an object of the invention to provide an adapter comprising a filter or sieve to which a sample and receiving tubes may each be secured such that the sample may be processed by during transit of the sample through the adapter and thus the sieve and/or filter comprised therein.

It is a further object of the invention that the assembled apparatus comprising sample vessel, receiving vessel and adapter should be suitable for processing the sample by way of centrifugation to urge the sample through the sieve and/or filter comprised therein.

The invention provides a sieving or filtering device having a first, open end and a second, closed end,
wherein at least a portion of the walls are perforated,
wherein the exterior of the device has means for mounting a first vessel in fluid connection with the first end of the device, and
wherein the exterior of the device has means for mounting a second vessel in fluid connection with the second end of the device,
   such that when the first and second vessels are mounted on the device a sealed volume is formed wherein the interior volumes of the first and second vessels and the interior volume of the device are in fluid connection.

A sealed volume in this context means a volume bounded by an effectively impervious membrane, surface, or shell. The effectively impervious layer may be formed from assembling a multiplicity of components together to form a continuous or contiguous layer.

The term perforated, in this context means that the perforated material is pierced with a hole, or holes. The perforated material may be planar or moulded or otherwise formed to have a three-dimensional form. Preferably the perforations are of uniform size.

In this context, the term mounted means to place or fix an object on a supporting object or structure. Also, in this context the walls of the sieving or filtering device also encompass the base of the device.

The sieving or filtering device may comprise portals or one or more perforations filled or covered with a sieve, mesh, or filter material.

In this context the term sieving refers to a process for separating wanted elements from unwanted material or for controlling the particle size distribution of a sample, by using a screen such as a mesh or net or perforated material. Thus sieving includes the act of passing matter through a sieve to change the particle size distribution, viscosity, or consistency of a sample. Thus sieving may be used to remove parts of a sample that are larger than the apertures in the sieve. Repeated sieving processes may serve to homogenise a sample to a degree defined by the size of the perforations in the sieve. Sieving also includes collecting the material, liquid and/or solid, from such a process that has passed through the sieve.

In this context, a filter is a porous device for removing solid particles from a liquid passed through it. Thus a sieve is a form of coarse filter. Thus a filter may comprise a filter medium which is preferably a porous article or membrane through which liquid may be passed in order to separate out matter therefrom. Thus filtering includes the act of passing a liquid through a filter to remove material therefrom. Filtering also includes collecting the liquid filtrate from such a process.

The perforated material may be selected from materials where the open area of the material is in the range 30%-40%, 40%-50%, 50%-60%, 60%-70%, 70%-80%, 80%-90%, and/or selected from materials where the open area of the material is 20%, 30%, 40%, 50%, 60%, 70%, 80%, or 90% open.

The proportion of open area of the perforated portion of the device may be in the range selected from 40-50%, 30-40%, 20%-30%, 10%-20%, 45-50%, 40%-45%, 35%-40%, 30%-35%, 25%-30%, 20%-25%, or 15%-20%.

The walls of the sieving or filtering device may be composed of perforated or mesh material, preferably the walls of the device are entirely composed of perforated or mesh material. This has the advantage of combining the body of the device with the sieving or filtering capacity of the surface area of the device. This has the consequent advantage of decreasing the effective volume taken up by the device in the assembly with the first and second vessels and thus increasing the volume available for accommodating sample for processing and/or the volume available for accommodating processed material.

A mesh is a material made of a network of wire or thread. Thus a mesh is an example of a perforated material. Accordingly, at least a portion of the walls of the sieving or filtering device may be made of a mesh material. Typically, a mesh material is composed of an array of elongate members arranged in a grid to define a repeating pattern of squares. Also typically, a mesh material may be moulded in this form, or such a form may be provided by weaving the elongate members together to form the warp and weft of the woven mesh material.

The perforations may be circular or geometric. The perforations may be arranged in a regular array. This array may have the perforations arranged at the vertices of a grid of squares, triangles, or hexagons.

Preferably the holes are 240 μm in diameter. Preferably the holes are 600 μm in diameter. It has surprisingly been discovered by the inventors that these sizes of perforation yield more efficient recovery of ova/oocytes of parasites, particularly parasites of canines (e.g. domestic dogs).

The fluid connection may be achieved via the holes of the perforations or via the voids in the mesh material of the sieving or filtering device.

The sieving or filtering device may be entirely contained within the volume of two vessels whose mouths abut together to provide a sealed volume.

Wherein the means may provide a fluid tight seal, preferably a liquid tight seal. The advantage of a fluid tight seal, which encompasses preventing the passage of gas as well as the passage of liquid is that odorous samples may be more easily treated and in a manner more pleasant for the user. Furthermore, biohazardous samples may be more easily treated and in a manner that is safer for the user. This is especially the case for biological sample such as faeces or stool. Thus a liquid tight seal has the advantage of being able to treat infectious, biological, or otherwise biohazardous samples with lower risk to the user and with less risk of contamination of equipment. Accordingly, laboratory processes may be more efficient.

Thus the first and second vessels may be mounted mouth-to-mouth with the sieving or filtering device mounted therebetween.

Preferably, the sieving or filtering device has a circumferential collar or flange. Most preferably the circumferential collar or flange is mounted on the exterior of the device. Thus when a vessel is mounted on the device the mouth of the vessel box with the collar to provide a seal. Accordingly, the first and second vessels may be simultaneously mounted and thus abut opposing surfaces (i.e., proximal, and distal surfaces) of the collar. In this way when the proximal and distal vessels are simultaneously mounted on the device a sealed volume is created with the device secured and preferably sealed between the mouths of opposed vessels.

Thus the collar of the sieving or filtering device may comprise one or more sealing surfaces on either or both sides in order to provide an improved seal. Most preferably the sealing surface is located on the surface of the collar abutting the mouth of the first and/or second vessel(s). Preferably the sealing surfaces are O-rings.

The means for mounting a first vessel may be one or more helical members circumferentially mounted on or formed in the surface of the sieving or filtering device. Preferably the one or more helical members is mounted on the exterior surface of the device. Thus the helical members provide a screw-thread surface or surfaces mounted on the device. Preferably two helical members are present for mounting the first vessel. That is, preferably the screw thread has a two starting points. However, screw threads with 1, 3, or 4 starts may also be used.

The means for mounting a second vessel may be one or more threaded helical members circumferentially fixed to the exterior surface of the sieving or filtering device. Preferably two helical members are present for mounting the second vessel. That is, preferably the screw thread has a two starting points. However, screw threads with 1, 3, or 4 starts may also be used.

Thus the mounting means may be a screw thread surface mounted or otherwise affixed to the exterior surface of the sieving or filtering device. The screw thread surface of the device is for interaction with a co-operating screw thread mounted, affixed, or formed circumferentially within the interior of the second vessel. Preferably the co-operating screw thread is mounted, affixed, or formed circumferentially within the mouth of the first vessel. Preferably the co-operating screw thread is mounted, affixed, or formed circumferentially within the mouth of the second vessel.

Thus the mounting means may comprise one or more screw thread surfaces mounted or otherwise affixed to the exterior surface of the sieving or filtering device. Preferably one screw thread is so mounted.

Such exterior screw threads are conventionally defined as being ‘male’. The screw thread surface of the sieving or filtering device is for interaction with a co-operating screw thread mounted, affixed, or formed circumferentially within the interior of the first vessel. Such co-operating screw threads are conventionally defined as being ‘female’.

The means for mounting a first vessel on the sieving or filtering device may be one or more protrusions or indentations that provide an interference or ‘click’ fit with cooperating indentations and/or protrusions on the exterior of the device. That is, minimal and transient deformation of components bearing the protrusions or indentations allow the protrusions past impediments so that they may reach and be accommodated in co-operating indentations. Furthermore, removal of the components bearing the protrusions or indentations is blocked by the restoring the shape of the component to its natural and undeformed state. Preferably the components bearing the protrusions or indentations are sufficiently resilient to spontaneously revert to the undeformed shape. The protrusions and indentations may be barbs or pawls on the device that lock against a co-operating serrated or ratchet surface on the mounted object, or vice versa.

The pattern of protrusions and indentations may form a ‘key’ in order that the vessels and device are aligned in a pre-determined orientation, according to the pattern of the protrusions and co-operating indentations of the ‘key’ portion of the interacting parts.

Preferably the screw thread is formed from the same material as the cooperating vessel. This may be achieved conveniently by manufacturing the vessel by injection moulding or 3D printing.

The closed end of the sieving or filtering device is its base. The base of the sieving or filtering device may be frustoconical. Part or all of the planar section of the frustoconical base may be unperforated or otherwise effectively impermeable material. This has the advantage of the sample material transiting the walls of the device being directed to move radially rather than only vertically during this passage. This has the advantageous effect of causing the material to be filtered to pass through a larger area of the walls of the device and thus makes it less likely that the pores or mesh of the device walls will be blocked. Accordingly, a greater volume of sample may be efficiently processed.

The use of larger volumes may yield richer data. In addition, processing of larger volumes may yield sufficient product that multiple tests may be carried out from a single sample. This has the advantage of more effective diagnosis with less patient sample required.

The base of the sieving or filtering device may be hemispherical. A central portion, preferably of circular diameter, of the base may be unperforated or otherwise effectively impermeable material, yielding the advantages noted above. Advantageously a hemispherical base allows even distribution of force across the surface and so may be more resistant to rupturing under pressure.

The base of the sieving or filtering device may be conical. A central portion, preferably of circular diameter, of the base may be unperforated or otherwise effectively impermeable material, yielding the advantages noted above.

Thus, in this context, a sieving or filtering device may have a base portion that is not sealed against the passage of liquid therethrough. In contrast, in this context a vessel is a container that is impermeable to the passage of liquid through the walls thereof.

The invention also provides a method for processing a substance comprising the steps of:
placing the substance inside a first co-operating vessel;
mounting a sieving or filtering device as described herein in fluid connection with the mouth of the first co-operating vessel, wherein the first, open end of the device faces the mouth of the first co-operating vessel;
mounting a second co-operating vessel in fluid connection with the device, wherein the second, closed end of the device points in the direction of the mouth of the second co-operating vessel;
   such that an assembly is formed containing a sealed volume wherein the interior volumes of the first and second vessels and the interior volume of the device are in fluid connection;
urging the material through the perforations or mesh material of the device.

That is, the invention provides a method for processing a substance comprising the steps of:
(a) placing the substance inside a first co-operating vessel;
(b) mounting a sieving or filtering device in fluid connection with the mouth of the first co-operating vessel, wherein the sieving or filtering device has a first, open end and a second, closed end, wherein at least a portion of the walls are perforated, wherein the exterior of the device has means for mounting a first open vessel in fluid connection with the first end of the device, and wherein the exterior of the device has means for mounting a second open vessel in fluid connection with the second end of the device, wherein the first, open end of the device is mounted to face the mouth of the first co-operating vessel;
(c) mounting a second co-operating vessel in fluid connection with the device, wherein the second, closed end of the device points in the direction of the mouth of the second co-operating vessel; such that an assembly is formed containing a sealed volume wherein the interior volumes of the first and second vessels and the interior volume of the device are in fluid connection; and
(d) urging the material through the perforations or mesh material of the device.

In the context of the present disclosure, the term “for” is defined to mean “suitable for” the purpose, method or objective defined in conjunction with this term.

Thus, in the course of carrying out the method described above the substance for processing is held within the first co-operating vessel. A sealed volume has been formed by mounting the first and second co-operating vessels on the sieving or filtering device. Accordingly, to cause the substance for processing to migrate or transit through the device the first co-operating vessel is conveniently inverted to cause the substance being processed to move into contact with the sieving or filtering device.

This arrangement means samples can be processed with a greater volume of substance or sample which allows the user to achieve a greater sensitivity when the processed material is used in tests or diagnostic assays. Preferably the sieving or filtering device extends into the second vessel. Most preferably, the sieving or filtering device extends into the second vessel rather than the first vessel. In this way a greater volume of sample may be accommodated in the first vessel. The consequence and advantage of this greater volume being included is to increase the overall sensitivity of assays utilising this apparatus.

Thus use of the present invention has the unexpected benefit of yielding higher specificity with fewer artefacts/debris when the processed sample is examined. Preferably examination is by microscopy and most preferably with the sample deposited, presented our mounted on a microscope slide for examination.

Additional advantages of the methods described herein, and devices and apparatus therefor, are increased sensitivity when processing samples containing a rare protozoan. Similarly the methods described herein, and devices and apparatus therefor, yield increased recovery of “scanty ova” (i.e. rarely occurring (scant) ova of pathogens, e.g. protozoa, in the sample) from sample materials. These improvements also yield easier morphological examination of pathogens or other materials in the processed material.

Further advantages of using the methods described herein, and devices and apparatus therefor, are increased efficiency of laboratory operations in terms of throughput, and in terms of achieving improved on-demand and patient-driven workflows.

The force to urge the material through the perforations or mesh material of the sieving or filtering device may be provided by centrifugation of the assembly. Thus, advantageously, viscous, partially liquid and/or semisolid materials may be processed by way of sieving or homogenisation by passage through the perforated material or mesh material. In addition, larger debris and/or contaminants may be retained by the device. Thus advantageously, the method allows for selection of material that is better suited that might not be suitable for

The force to urge the material through the perforations or mesh material of the sieving or filtering device may be provided by shaking or vibrations of the assembly. Thus, advantageously, powders and similar materials may be processed by way of sieving a portion of the material by passage of the material through the perforated material or mesh material. Optionally, material larger than the size of the perforations or holes of the mesh material may be retained by the material of the device. This has the advantage of allowing small volumes of particulate matter to be accurately separated by size.

Wherein the processing is achieved by passage through a material selected from sieve, perforated material, or mesh material. Preferably these materials are planar, most preferably these materials are planar and shaped according to a predetermined contour.

The invention further provides a system comprising an injection moulding tool for manufacturing a sieving or filtering device as disclosed herein.

The invention further provides a system comprising an injection moulding tool for manufacturing the first and/or second cooperating vessel(s) as described herein.

The invention also provides a kit comprising a sieving or filtering device as disclosed herein, together with a cooperating vessel. The device may be pre-installed in the cooperating vessel, preferably it is pre-installed in the second vessel. Thus, advantageously the preinstalled device may be further mounted conveniently on a vessel containing a sample, i.e. a first vessel as described herein. Thus the filtration process is simplified.

The terms seats and seated are defined in the present context to mean to be fitted in position. Further, in the context of the present disclosure that means that a device is fitted in the correct and/or predetermined position in the cooperating laboratory tube.

The sieving or filtering device of the present invention is for cooperative use with a vessel. This is preferably a compatible laboratory tube.

The substance processed using the device, apparatus and/or methods described herein may be a biological sample. Thus, the apparatus and methods disclosed herein are suitable for processing of biological samples, e.g. stool, faeces, human or animal tissue, urine, blood, lymph, plasma, cerebrospinal fluid, saliva. Preferably, the sample is a stool or faecal sample. The substance or sample may be mixed with a solution or reagent that may be selected from a diluent, a buffer, a fixative, or a test reagent.

The samples by be assessed by wet mounting in saline or other liquid, preferably saline. The samples by be assessed by trichrome staining, preferably Wheatley trichrome staining.

The samples may be fixed before assessment and/or additional testing. The fixative may be selected from Total-Fix (Medical Chemical Corporation, Fisher Scientific UK); Modified Cupric Sulfate [Sulphate]-Polyvinyl Alcohol Cu-PVA) (Fisher Heathcare, UK); and Zinc Sulfite [Sulphite]-Polyvinyl Alcohol (Zn-PVA) (Fisher Heathcare, UK); and/or EcoFix (Meridian Bioscience, Fisher Scientific UK). Preferably, a single fixative from this list is used.

The sieving or filtering device may be manufactured by techniques such as injection moulding of plastics material to produce the measuring devices in large numbers. This simplicity of manufacture has the attendant advantage that the measuring device may be disposable. Similarly the cooperating vessels may be manufactured by techniques such as injection moulding of plastics material.

Laboratory tubes are conveniently used for holding and processing volumes of liquids. These may be samples of biological origin or other liquids. Accordingly, the definition of liquid in the context of the present disclosure includes pure liquids and also suspensions of matter in liquids. Accordingly, the measuring device disclosed herein may be suitable for operation in the context of liquids and/or suspensions.

The one or both of the first and second vessels may be of the standard volumes and/or dimensions of laboratory tubes produced by Eppendorf®, Stirling®, Falcon®; or generic versions and/or variants thereof. Thus, advantageously, the measuring device may be made to be compatible with a wide range of standard and widely used laboratory tubes.

Accordingly, the laboratory tube may be round, elliptical, or circular in transverse cross-section. Preferably, the laboratory tube is substantially circular in transverse cross-section.

Thus the laboratory tube may be designed to have a total volume of 2.5 ml, 2 ml, 1.5 ml, 1 ml, or 0.5 ml.

The measuring device may be made of plastics material. Preferably, the plastics material is injection moulded. however, the plastics material may be 3-D printed. The measuring device may be manufactured from one or more plastics material selected from the following list: acrylic (PMMA); acrylonitrile butadiene styrene (ABS) polyamide (PA; nylon); polycarbonate (PC); polyethylene (PE); polyoxymethylene (POM); polypropylene (PP); polystyrene (PS); thermoplastic elastomer (TPE); or thermoplastic polyurethane (TPU). Preferably the plastics material selected is polypropylene. Preferably the plastics material selected is polyethylene, most preferably the plastic material is high density polyethylene (HDPE).

The plastics material may be biologically inert. In this context biologically inert means that the plastics material does not react with biological material that it comes into contact with. Accordingly, such a biologically inert material does not affect the results of tests, or assays carried out on biological samples or liquids that it is brought into contact with. More preferably these are plastics materials which are characterised by low absorbance of protein, such as polypropylene and/or polycarbonate.

The walls of the non-cylindrical section of the sieving or filtering device may taper inwards as device protrudes into the second, receiving vessel. The tapering may be linear, e.g. the inner surface may have the form of a truncated cone. Alternatively, the tapering may be discontinuous, e.g. to provide a funnel surface to more efficiently directed the sample material through the perforations or mesh of the device.

Once the sample has been processed by passage through the walls of the sieving or filtering device, then the process sample retained in the base of the cooperating second vessel, then all or part of that volume of liquid or suspension, e.g. the supernatant, and may be removed. Preferably, the liquid or suspension is removed by its withdrawal by a pipe inserted into the passage of the measuring device. Withdrawal of the liquid via the pipe may be achieved by a number of standard means. Preferably, this is by means of generation of a partial vacuum by the operation of a piston or suction developed by the reinflation of a pipette bulb. Accordingly, the pipe may be a pipette tip or hollow (e.g. hypodermic) needle. Preferably, the pipe is a pipette tip.

### EXAMPLES AND DRAWINGS

The invention will now be described with reference to the following drawings and examples in which:

FIG. 1A shows a cross-sectional view of a sieving device for locating in a cooperating vessel, e.g. a laboratory tube, via a co-operating screw thread. The cross section is taken along section A-A, as shown in FIG. 1B.

FIG. 1B shows a view along the central axis towards the closed base of the sieving device shown in FIG. 1A.

FIG. 2 and its constituent diagrams FIGS. 2a and 2b are identical to those shown in FIG. 1 but shows the specific dimensions of the device in millimetres.

FIG. 3 (upper left) shows a side view of a sieving device for locating in a cooperating vessel, e.g. a laboratory tube, via a co-operating screw thread. A cross-sectional view is shown in the upper right. The cross section is taken along section A-A. The lower left drawing shows a view along the central axis towards the closed base of the sieving device shown.

FIG. 4 shows an isometric view of a sieving device for locating in a cooperating vessel, e.g. a laboratory tube, via a co-operating screw thread.

FIG. 5 (right) shows a side view of a sieving device for locating in a cooperating vessel, e.g. a laboratory tube, via a co-operating screw thread. FIG. 5 (left) shows a view along the central axis towards the closed base of the sieving device shown.

FIG. 6 (left) shows a view along the central axis towards the closed base of the sieving device shown in FIG. 6 (right). FIG. 6 (right) shows a cross-sectional view of a sieving device for locating in a cooperating vessel, e.g. a laboratory tube, via a co-operating screw thread. The cross section is taken along section A-A, as shown in FIG. 6 (left). The longer frustoconical cone section of the device of FIG. 6 compared with the device of FIG. 5 has the advantage of achieving greater sensitivity with a high volume of sample.

FIG. 7 (upper left) shows a side view of a first vessel as described herein with a female screw thread at the opening for mounting a sieving or filtering device on the first vessel. A cross-sectional view is shown in the upper right. The cross section is taken along section A-A shown in FIG. 7 (upper left). The lower left drawing shows a view along the central axis towards the closed base of the first vessel shown.

FIG. 8 (upper right) shows a side view of a screw tap stopper with a male screw thread for sealing a first vessel as described herein with a cooperating female screw thread at the opening thereof. A cross-sectional view is shown at the left. The cross section is taken along section A-A shown in FIG. 8 (upper right). The lower right drawing shows a view along the central axis towards the base of the stopper shown.

FIG. 9 (upper left) shows a side view of a second vessel as described herein with a female screw thread at the opening for mounting a sieving or filtering device on the second vessel. A cross-sectional view is shown in the upper right. The cross section is taken along section A-A shown in FIG. 9 (upper left). The lower right drawing shows a view along the central axis towards the closed base of the first vessel shown.

FIG. 10 shows an isometric view of an assembled apparatus comprising a first vessel as described herein mounted on the proximal end of a sieving device as described herein, and a second vessel as described herein mounted on the distal end of the sieving device.

FIG. 11 shows an isometric view of an assembled apparatus comprising a first vessel as described herein mounted on the proximal end of a sieving device as described herein, and a second vessel as described herein mounted on the distal end of the sieving device. Thus the sieving device and means of securing the first and second vessels is as shown in FIG. 10 but the volumes of the first and second vessels are smaller, as shown by their shorter lengths.

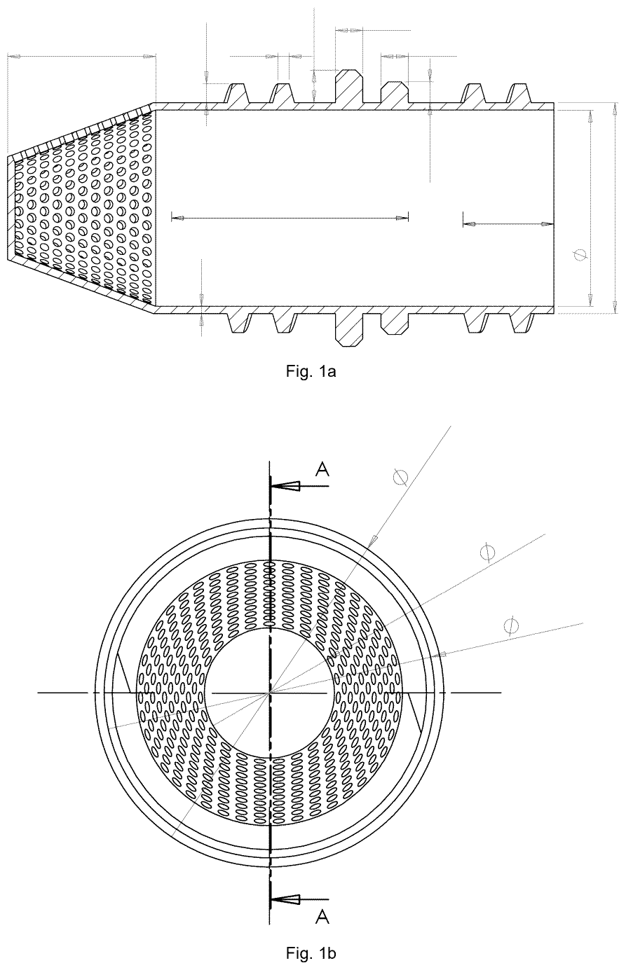

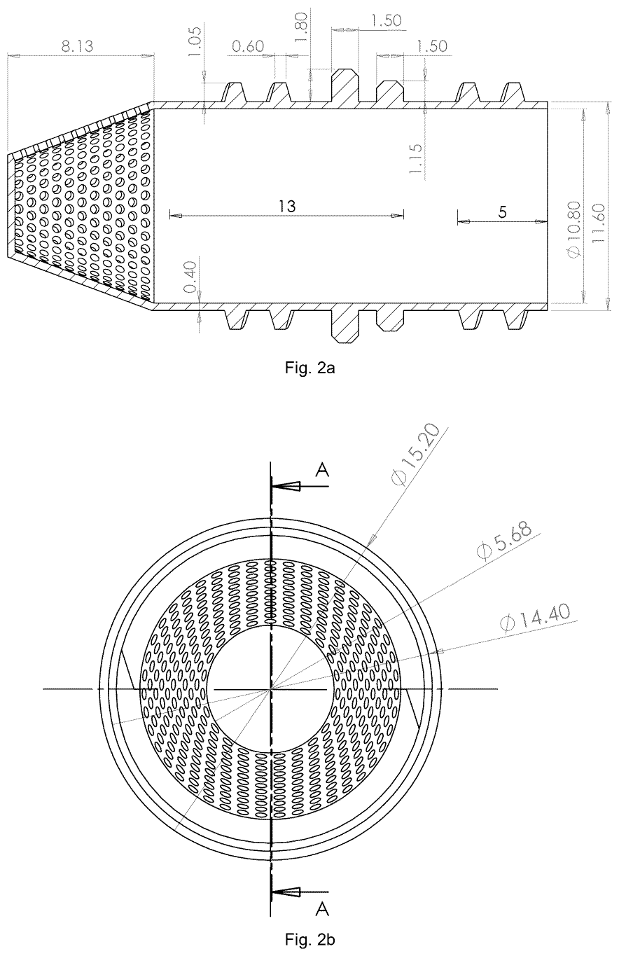

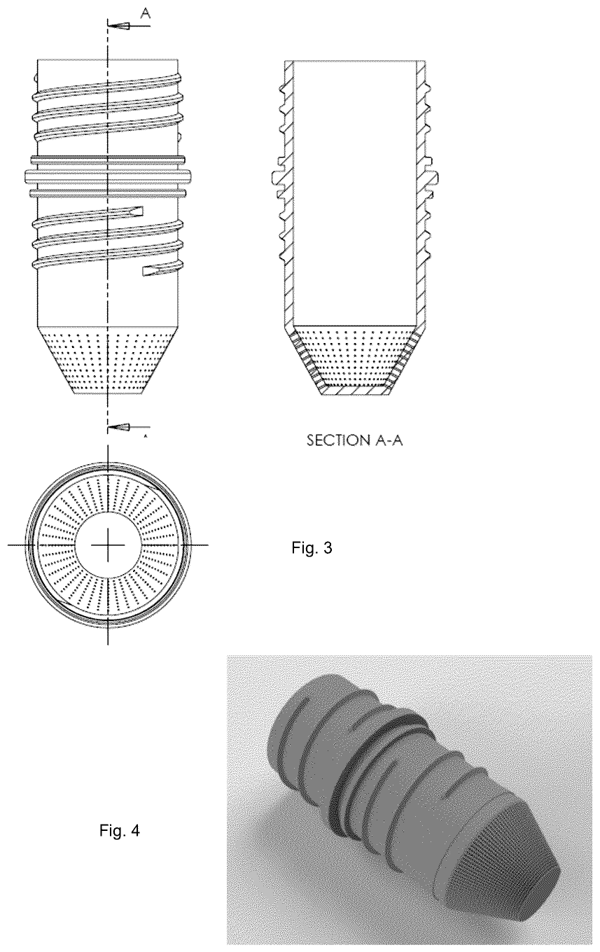

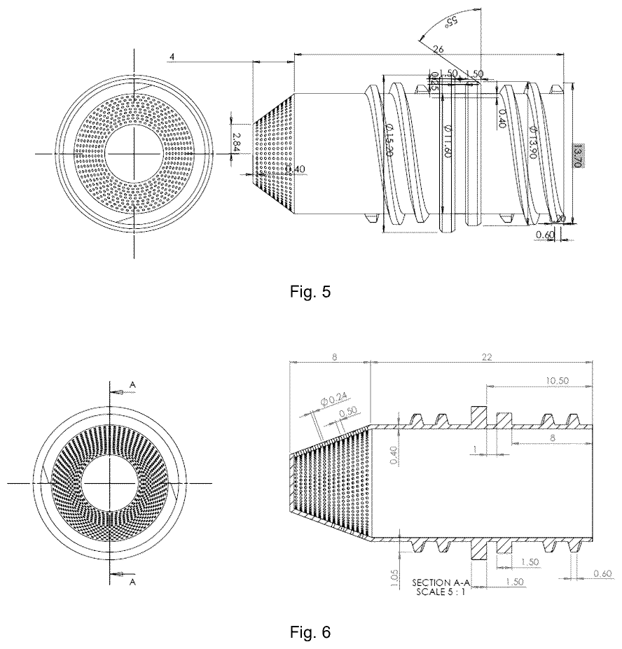

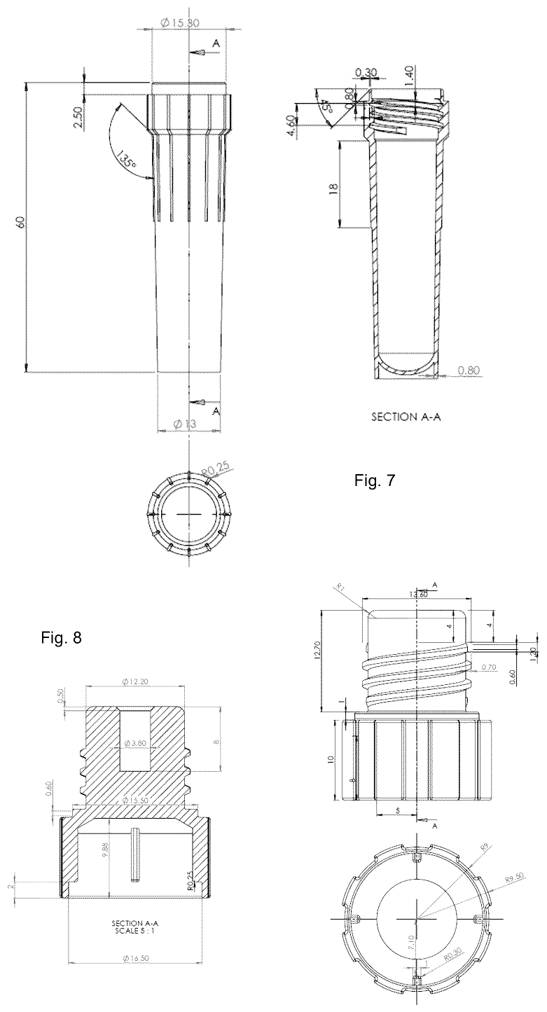

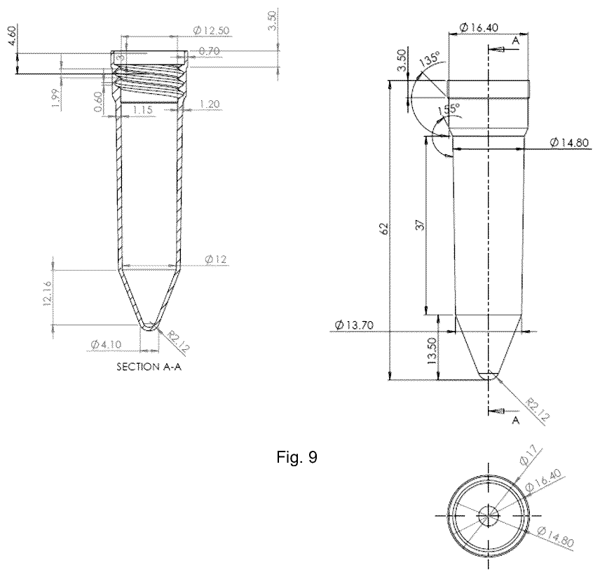

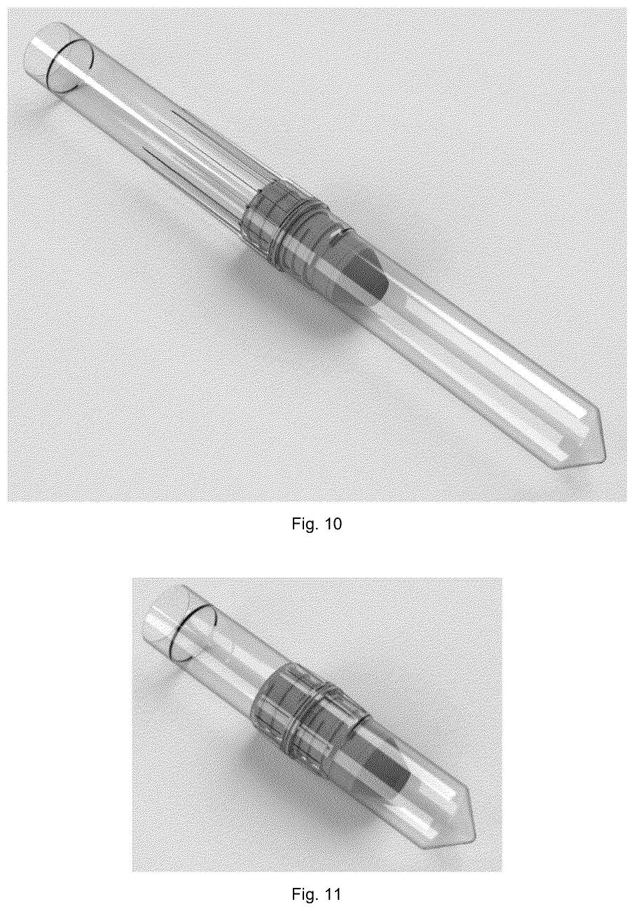

### EXAMPLE 1

Typically a faeces or stool sample will be obtained in a clinical or veterinary setting, e.g. a clinic or hospital. and then stored in a fixative agent, such as formaldehyde. The faeces or stool sample may be human or animal in origin. Alternatively, the sample may be directly added to an alternative storage medium, e.g. a buffer solution. As a further alternative the sample might be directly added to a testing reagent.

Thus, the sample and is added to the interior of a first vessel. The first vessel is made of injection moulded plastics material. The vessel has an open mouth and a female screw thread surface formed on the interior surface of the mouth.

The open mouth of the first vessel is kept pointing upwards, while a sieving or filtering device as described herein is screwed into the mouth of the first vessel with the open end of the device facing into the first vessel such that the partially obstructed/closed end of the device is pointing outwards.

The sieving or filtering device comprises a body with a hollow cylindrical section having a first open end and with the second end of the cylinder being partially obstructed by an outwardly pointing truncated cone (i.e. a frustoconical shape).

In one version of the device all or a portion of the body of the device is perforated by an array of regularly spaced circular holes. In one embodiment the holes are 240 μm in diameter and in a second embodiment they are 600 μm in diameter.

In a further, alternative, version of the device the body of the device comprises areas made of a mesh material or portals covered thereby. In one embodiment of the device the body of the device is entirely made of mesh material.

Upon the exterior surface of the cylindrical section is mounted a circumferential collar at the midpoint of the exterior surface of the device, wherein the plane of the collar is perpendicular to the central axis of the cylinder. Two male screw thread surfaces are formed or mounted at each end of the cylindrical section and run from the end of the cylindrical section to the central collar. The collar and screw threads are made from substantially solid plastics material. Thus the device is rotated sufficiently to yield sufficient axial movement to cause the urge the mouth of the first vessel to abut the collar of the device such that a liquid tight seal is formed.

A second vessel is then screwed over the exposed end of the device. The second vessel is made of injection moulded plastics material. The vessel has an open mouth and a female screw thread surface formed on the interior surface of the mouth.

The first and second vessels are screwed onto the body of the device so that the edges of the mouths of the first and second vessels firmly abut the collar of the device body in order to provide a seal therewith.

The assembly so formed is then subjected to acceleration by centrifugation (preferably at 400 g for 2 minutes) to cause the sample to travel through the perforated parts of the device. The material that transits the walls of the device is collected as a pellet and supernatant in the second vessel.

The retained liquid volume and/or pellet may then be simply removed by way of a standard techniques, e.g. with a pipette and then used for further testing or processing. In the present example the processed samples were tested to measure the frequency of parasite ova/oocysts therein.

The data set out in Table 1, below, is a collation of the frequency of parasite ova/oocysts detected in samples from a canine that were processed using the method described above. Columns A and B show data obtained from carrying out this method using the apparatus described above according to the present invention. Columns 1 and 2 show comparative data obtained by processing the sample with using previously available apparatus and methods.

TABLE 1

Number of Ova/Oocysts

| Ova/Oocysts Species | A | B | 1 | 2 |
|---|---|---|---|---|
| Ancylostoma (hookworm) | 25 | 24 | 8 | 13 |
| Cystoisospora (coccidia) | 7 | 7 | 3 | 3 |
| Giardia | 0 | 0 | 0 | 0 |
| Taeniidae (tapeworm) | 4 | 3 | 1 | 1 |
| Toxocara (roundworm) | 19 | 17 | 13 | 19 |
| Trichuris (whipworm) | 1 | 0 | 1 | 0 |

Thus use of the apparatus of the invention disclosed herein yields significantly more efficient recovery of parasite ova/oocysts and therefore yields a more sensitive test for parasite infection.

### EXAMPLE 2

Typically a faeces or stool sample will be obtained in a clinical or veterinary setting, e.g. a clinic or hospital. and then stored in a fixative agent, such as formaldehyde. The faeces or stool sample may be human or animal in origin. Alternatively, the sample may be directly added to an alternative storage medium, e.g. a buffer solution. As a further alternative the sample might be directly added to a testing reagent.

In a specific example a sample is prepared for further processing according to the following steps:
Introducing an appropriate volume (typically 3 ml) into a sample vial of fixative agent, such as formaldehyde, alternative storage medium, such as a buffer solution, or a testing reagent in a sample vial.
Using a measuring scoop integrally attached to the inner surface of a stopper for the vial to scoop and thus measure a stool sample. Thus the sample can be conveniently inserted into the sample vial and the vial sealed with the stopper as part of a single process.

The sample is emulsified in the liquid in the vial by then vortexing or agitating the assembly. The sample is now suitable for further processing using the methods and apparatuses described herein.

In particular the vial containing the vortexed sample can be used as the ‘first vessel’ according to the methods above.

### EXAMPLE 3

The sieving or filtering device is produced by injection moulding of plastics material. Preferably polypropylene is used. Thus the perforated device body with screw threads thereon may be manufactured by a single injection moulding step to form a unitary whole.

### EXAMPLE 4

In an alternative method of manufacture, the screw threads and collar of the sieving or filtering device describe herein may be produced by over moulding of a pre-formed mesh device body in a suitable injection moulding tool. Suitably, the mesh is made of the same plastics material as the over moulded screw threads and collar. Thus the mesh device body and further components are then formed as a unitary whole.

### EXAMPLE 5

Table 2 shows comparative results of testing human stool samples between apparatus of the present invention and the current industry standard (i.e. the current “Gold standard” Parasep® manufactured by Apacor, Wokingham, Berkshire, UK)

The sample processing methods are as set out above. The processed samples were assessed using standard techniques. The samples were observed by wet mounting in saline or other liquid (WM) or trichrome staining (e.g. Wheatley trichrome staining).

The annotation “+n” in Table 2 represents a description of the sensitivity of the test. “+n” represents the abundance or number of parasitic organisms seen, wherein “rare” or “+1” denotes low abundance, and +2 denotes a significantly greater number of organisms.

TABLE 2

| | | | | | Present Invention: | | |
|---|---|---|---|---|---|---|---|
| | Reported | | Prior Art - “Parasep” | | “Paradevice” | | |
| No. | Organism(s) | Fixative | WM | TR | WM | TR | Notes |
| 1 | Endolimax | Total-Fix | Negative | Rare En | Negative | Rare En | |
| | nana (En) | | | trophs | | trophs | |
| 2 | Dientamoeba | Cu-PVA | Trophs | Df | Trophs | Df | Clearer |
| | fragilis (Df) | | | | | Ec trophs | background |
| | Entamoeba | | | | | | with |
| | coli (Ec); | | | | | | Paradevice |
| 3 | Chilomastix | Zn-PVA | Cm trophs; | Cm trophs | Cm trophs | Cm trophs | Interfering |
| | mesnili (Cm) | | interfering | | | | substances |
| | | | substances | | | | for prior art |
| | | | | | | | not present |
| | | | | | | | for |
| | | | | | | | Paradevice |
| 4 | Giardia | EcoFix | Not | Ec (cysts | Gd cysts | Gd (rare) | Clearer |
| | duodenalis | | detected | rare) | (rare) | Ec trophs | background |
| | (Gd) | | | | Ec cysts | (rare) | with |
| | Entamoeba | | | | (rare) | | Paradevice |
| | coli (Ec); | | | | | | |
| 5 | Entamoeba | Zn-PVA | Interfering | Eh Ed | Interfering | Eh Ed | Clearer |
| | histolytica | | substances | cysts | substances | cysts | background |
| | (Eh); | | | | | | with |
| | Entamoeba | | | | | | Paradevice |
| | dispar (Ed); | | | | | | |
| | 1+ | | | | | | |
| | Blastocystis | | | | | | |
| 6 | Iodamoeba | Zn-PVA | Trophs | Df | Trophs | Df | Clearer |
| | buetschlii (lb) | | | lb/En | | lb/En | background |
| | Dientamoeba | | | | | | with |
| | fragilis (Df) | | | | | | Paradevice |
| 7 | Dientamoeba | EcoFix | Protozoan | Df trophs | Protozoan | Df trophs | |
| | fragilis (Df) | | trophs | | trophs | | |
| 8 | 2+ | EcoFix | Blasto | 1+ Blasto | Blasto | 2+ Blasto | |
| | Blastocystis | | (rare) | | (rare) | | |
| 9 | Entamoeba | Zn-PVA | Ec cysts | Ec | Ec cysts | Ec | |
| | coli (Ec); | | | cysts/trophs; | | cysts/trophs; | |
| | Endolimax | | | En | | En | |
| | nana (En) | | | trophs | | trophs | |
| 10 | Strongyloides | EcoFix | Strongy | Strongy | Strongy | Strongy | Clearer |
| | stercoralis | | Blasto | Blasto | Blasto | Blasto | background |
| | (Strongy); | | (rare) | (rare) | (rare) | (rare) | with |
| | Endolimax | | | En | | En | Paradevice |
| | nana (En); | | | | | | |
| | Entamoeba | | | | | | |
| | hartmanni | | | | | | |
| | (Eh); | | | | | | |
| | 1+ | | | | | | |
| | Blastocystis | | | | | | |
| | (Blasto) | | | | | | |

A trophozoite (“troph” or plural “trophs”) is the activated, feeding stage in the life cycle of certain protozoa. The complement of the trophozoite state is the thick-walled cyst form, which is a resting or dormant stage of the microorganism.

The fixatives used were: Total-Fix (Medical Chemical Corporation, Fisher Scientific UK); Modified Cupric Sulphate [Sulfate]-Polyvinyl Alcohol Cu-PVA) (Fisher Heathcare, UK); and Zinc Sulphite [Sulfite]-Polyvinyl Alcohol (Zn-PVA) (Fisher Heathcare, UK); EcoFix (Meridian Bioscience, Fisher Scientific UK).

As demonstrated by the results set out in Table 2, use of apparatus of the present invention (provisional trade mark “Paradevice”) advantageously yields higher specificity with fewer artefacts and/or less debris to be examined on the sample slides.

Thus the invention provides a method of sieving or filtering solid or semisolid biological samples. Additionally, it is an object of the invention that the resulting matter and/or liquid should be conveniently collected by centrifugation in a compatible laboratory tube. Accordingly, the invention also provides a sieving or filtering device having a first, open end and a second, closed end, wherein at least a portion of the walls are perforated, wherein the exterior of the device has means for mounting a first open vessel in fluid connection with the first end of the device, and wherein the exterior of the device has means for mounting a second open vessel in fluid connection with the second end of the device, such that when the first and second vessels are mounted on the device a sealed volume is formed wherein the interior volumes of the first and second vessels and the interior volume of the device are in fluid connection. In addition, a system for manufacturing the filtering device comprising an injection moulding tool is also provided. These developments offer improvements to the convenience and efficiency of sieving or filtering biological samples, e.g. stool or faecal material. and also improvements in the consistency and efficiency of processing these materials.

1. A sieving or filtering device having a first, open end and a second, closed end,
wherein at least a portion of the walls are perforated,
wherein the exterior of the device has means for mounting a first open vessel in fluid connection with the first end of the device, and
wherein the exterior of the device has means for mounting a second open vessel in fluid connection with the second end of the device,
such that when the first and second vessels are mounted on the device a sealed volume is formed wherein the interior volumes of the first and second vessels and the interior volume of the device are in fluid connection.

2. The sieving or filtering device according to claim 1, wherein the sieving or filtering device has a circumferential collar or flange.

3. The sieving or filtering device according to claim 1, wherein the device comprise portals or perforations filled or covered with a sieve, mesh, or filter material.

4. The sieving or filtering device according to claim 1, wherein the means for mounting the first and/or second vessel provides a fluid tight seal.

5. The sieving or filtering device according to claim 1, wherein the closed end of the device is frustoconical.

6. The sieving or filtering device according to claim 1, wherein the means for mounting the first and/or second vessel is a cooperating screw-thread surface mounted on a surface of the sieving or filtering device.

7. The sieving or filtering device according to claim 1, wherein the sieving or filtering device has a circumferential collar or flange.

8. The sieving or filtering device according to claim 1, wherein the first and/or second vessels are laboratory and/or centrifuge tubes.

9. A method for processing a substance comprising the steps of:
(a) placing the substance inside a first co-operating vessel;
(b) mounting a sieving or filtering device in fluid connection with the mouth of the first co-operating vessel, wherein the sieving or filtering device has a first, open end and a second, closed end, wherein at least a portion of the walls are perforated, wherein the exterior of the device has means for mounting a first open vessel in fluid connection with the first end of the device, and wherein the exterior of the device has means for mounting a second open vessel in fluid connection with the second end of the device, wherein the first, open end of the device is mounted to face the mouth of the first co-operating vessel;
(c) mounting a second co-operating vessel in fluid connection with the device, wherein the second, closed end of the device points in the direction of the mouth of the second co-operating vessel; such that an assembly is formed containing a sealed volume wherein the interior volumes of the first and second vessels and the interior volume of the device are in fluid connection; and
(d) urging the material through the perforations or mesh material of the device.

10. The method according to claim 9, wherein the substance is a human or animal biological sample.

11. The method according to claim 9, wherein the substance is a stool or faecal sample.

12. An apparatus comprising a sieving or filtering device of claim 1, and a first cooperating vessel mounted thereon.

13. The apparatus of claim 12, further comprising a second cooperating vessel mounted thereon.

14-15. (canceled)

16. The sieving or filtering device according to claim 1, wherein the perforations are holes of 240 μm or 600 μm in diameter.

17. The sieving or filtering device according to claim 1, wherein the means for mounting the first and/or second vessel provides a fluid tight seal.

18. The sieving or filtering device according to claim 5, wherein the planar section of the frustoconical base may be unperforated or otherwise of impermeable material.

19. A sieving or filtering device according to claim 1, wherein the closed end of the device is hemispherical.

20. The sieving or filtering device according to claim 19, wherein the central portion of the base may be unperforated or otherwise impermeable material, preferably the central portion is circular.

21. The sieving or filtering device according to claim 1, wherein the closed end of the device is conical.

22. The sieving or filtering device according to claim 21, wherein the central portion of the base may be unperforated or otherwise impermeable material, preferably the central portion is circular.
